(19) United States
(12) Patent Application Publication
(10) Pub. No.: US 2005/0214629 A1
(43) Pub. Date: Sep. 29, 2005

(54) Perfluoroalkanesulfonic acids and perfluoroalkanesulfonimides as electrode additives for fuel cells

(76) Inventors: Sekharipuram R. Narayanan, Arcadia, CA (US); Marshall C. Smart, Studio City, CA (US); Subbarao Surampudi, Glendora, CA (US); G. K. Surya Prakash, Hacienda Heights, CA (US); Qun-jie Wang, Los Angeles, CA (US); George A. Olah, Los Angeles, CA (US)

Correspondence Address: CHRISTIE, PARKER & HALE, LLP, PO BOX 7068, PASADENA, CA, 91109-7068, US

(21) Appl. No.: 10/956,835

(22) Filed: Oct. 1, 2004

Related U.S. Application Data
(60) Provisional application No. 60/508,005, filed on Oct. 1, 2003.

(51) Int. Cl. H01M 4/86; H01M 4/92

(52) U.S. Cl. 429/42

(57) ABSTRACT

Coating materials for coating the electrodes of a fuel cell are disclosed. In one embodiment, the coating materials comprise perfluoroalkanesulfonic acids having the general formula F₃C—(CF₂)ₙ—SO₃H, wherein n ranges from 8 to 17. In another embodiment, the coating materials comprise perfluoroalkanesulfonimides having the general formula CₙF₂ₙ₊₁SO₂NHO₂SF₂ₘ₊₁Cₘ, wherein the sum of m and n ranges from 8 to 17. These long chain sulfonic acids and imides impart improved electrode performance and decrease polarization.

### CROSS REFERENCE TO RELATED APPLICATION

This application claims priority of Provisional Application Ser. No. 60/508,005, filed Oct. 1, 2003, entitled PERFLUOROALKANESULFONIC ACIDS AND PERFLUOROALKANESULFONIMIDES AS ELECTRODE ADDITIVES FOR DMFCs, the entire disclosure of which is incorporated herein by reference.

### STATEMENT AS TO FEDERALLY SPONSORED RESEARCH

The U.S. government has certain rights in this invention pursuant to Grant No. NAS7-1407, awarded by the National Aeronautics and Space Administration.

### FIELD OF THE INVENTION

This invention is directed to additives for coating an anode in a fuel cell, and to fuel cells with electrodes coated with these additives.

### BACKGROUND OF THE INVENTION

A traditional direct methanol fuel cell (“DMFC”) comprises a cathode, an anode and an electrolyte membrane. The DMFC normally also includes catalysts between the anode and the electrolyte membrane and between the cathode and the electrolyte membrane. The DMFC operates through the continuous feed of methanol to the anode. The methanol is electrochemically oxidized at the anode and corresponding catalyst layer. This oxidation of methanol produces electrons which travel through an external circuit to the cathode and corresponding catalyst layer. Meanwhile, the electrolyte conducts protons from the anode to the cathode in order to maintain the circuit within the fuel cell. The oxygen at the cathode then consumes the electrons together with the protons in a reduction reaction. The electrons, protons and oxygen gather at the cathode and form water. Theoretically, all the free chemical energy associated with the oxidation of methanol in the direct methanol fuel cell is converted to electrical energy. However, polarization of the electrodes prevents the fuel cells from achieving such high efficiency.

Protonic polymer electrolyte membranes, such as Nafion®, have proven particularly useful in reducing the drawbacks associated with increased polarization in DMFCs. In particular, Nafion® imparts improved electrode performance and interfacial properties. Accordingly, Nafion® has been used as a coating for DMFC electrodes. DMFCs using Nafion® coated electrodes exhibit improved contact between the electrode and electrolyte membrane, improved catalyst utilization, extension of the three-dimensional reaction zone, decreased ohmic losses, and prevention of poisoning the catalytic material by the adsorption of anions. Most significantly, however, the Nafion® coated electrodes improve the wettability and permeability of the electrodes. The improved wettability and permeability of the electrodes is particularly significant in DMFCs because the anode must be wetted to facilitate methanol transport and carbon dioxide rejection.

In addition to protonic polymeric coating materials, like Nafion®, short chain (from 1 to 2 carbon atoms) water soluble perfluoroalkanesulfonimides have been used as electrolyte materials and as electrode additives in the cathodic reduction of oxygen. These perfluoroalkanesulfonimides are electrochemically stable under acidic conditions, making them desirable for use in DMFCs. However, electrodes coated with these short chain perfluoroalkanesulfonimides do not exhibit the same improvements in performance as electrodes coated with Nafion®. Accordingly, a need exists for an electrochemically stable perfluoroalkanesulfonimide electrode coating material that imparts the same or better improved electrode performance in DMFCs than that achieved by a Nafion® coating, and that reduces polarization of the electrodes.

### SUMMARY OF THE INVENTION

The present invention is directed to alternative coating materials for fuel cell electrodes. In one embodiment, the coating material comprises a material selected from the group consisting of perfluoroalkanesulfonic acids, where the alkane group comprises between 8 and 17 carbon atoms. Preferably, the alkane group comprises 12 carbon atoms.

In another embodiment, the coating material comprises a material selected from the group consisting of perfluoroalkanesulfonimides having the general formula CₙF₂ₙ₊₁SO₂NHO₂SF₂ₘ₊₁Cₘ, where the sum of m and n ranges from 8 to 17. Preferably, m equals 8 and n equals 8. Alternatively, m equals 4 and n equals 4. In another alternative, n equals 4 and m equals 8. In yet another embodiment, the coating material is selected from the group consisting of perfluorooctanesulfonic acid, perfluorododecanesulfonic acid, perfluoroheptadecanesulfonic acid, bis-perfluoro-n-butylsulfonimide, bis-perfluoro-octylsulfonimide, and perfluoro-n-butyl-perfluoro-n-octylsulfonimide.

The electrode coating materials of this invention have high proton concentration. Protonic polymer coating materials, such as Nafion® have much lower proton concentrations. As a result, to achieve the same proton concentration as in the coating materials of the present invention, much more Nafion® must be used. Among other concerns, increasing the amount of Nafion® increases hydrophobicity due to the Nafion® backbone, hampers catalytic activity and increases cost.

### BRIEF DESCRIPTION OF THE DRAWINGS

These and other features and advantages of the present invention will be better understood by reference to the following detailed description when considered in conjunction with the accompanying drawings wherein:

FIG. 1 is a graphical comparison of polarization curves for the oxidation of 1.0 M methanol in a 0.5 M H₂SO₄ solution at a carbon supported Pt—Sn electrode coated with Nafion® to electrodes coated with three alternative embodiments of the coating material according to the invention;

FIG. 2 is a graphical comparison of polarization curves for the oxidation of 1.0 M methanol in a 0.50 M H₂SO₄ solution at 23° C. at carbon supported Pt—Sn electrodes coated with six alternative embodiments of the coating material according to the invention;

FIG. 3 is a graphical comparison of polarization curves for the oxidation of 1.0 M methanol in a 0.50 M H₂SO₄ solution at a carbon supported Pt—Sn electrode coated with Nafion® to electrodes coated with two alternative embodiments of the coating material according to the invention;

FIG. 4 is a graphical comparison of polarization behavior of Nafion® coated electrodes to three alternative embodiments of the coating material according to the invention measured at 0.5 mA/cm² as a function of coating thickness;

FIG. 5 is a graphical comparison of polarization behavior of electrodes coated with one embodiment of the coating material according to the invention at different coating thicknesses;

FIG. 6 is a graphical comparison of polarization curves for the oxidation of methanol on carbon supported Pt—Sn electrodes coated with Nafion® to electrodes coated with one embodiment of the coating material according to the invention, measured at both 23° C. and 50° C.;

FIG. 7 is a graphical comparison of polarization curves for the oxidation of methanol on carbon supported Pt electrodes coated with Nafion® to electrodes coated with three alternative embodiments of the coating material according to the invention;

FIG. 8 is a graphical comparison of polarization curves for the oxidation of methanol on carbon supported Pt—Ru electrodes coated with Nafion® to electrodes coated with three alternative embodiments of the coating material according to the invention;

FIG. 9 is a graphical compansion of stability of Pt—Sn electrodes coated with Nafion® to electrodes coated with one embodiment of the coating material according to the invention;

FIG. 10 is a graphical comparison of the results of cyclic voltammograms taken in 0.5 M H₂SO₄ of carbon supported Pt electrodes coated with Nafion® to electrodes coated with one embodiment of the coating material according to the invention; and

FIG. 11 is a schematic depicting a fuel cell according to one embodiment of the invention.

### DETAILED DESCRIPTION

The present invention is directed to electrode additives for use in fuel cells, and to fuel cells with electrodes coated with these additives. Although the invention is described with reference to direct methanol fuel cells, it is understood that the coating materials of this invention can be used with any fuel cell using fuels such as hydrogen, formic acid, ethanol, dimethoxymethane, trimethoxymethane, and related organics.

In one embodiment, the additive comprises one or more materials selected from the group consisting of perfluoroalkanesulfonic acids represented by the general formula: F₃C—(CF₂)ₙ—SO₃H, where n ranges in value from 8 to 17. Preferably, however, n equals 12. When n is greater than 17 the coating material becomes highly hydrophobic. When n is less than 8 the coating material becomes highly hydrophilic. Highly hydrophilic or highly hydrophobic coating materials are not desirable for use in direct methanol fuel cells.

In an alternative embodiment, the coating material comprises one or more materials selected from the group consisting of perfluoroalkanesulfonimides. The perfluroalkanesulfonimides useful in the present invention have the general formula: CₙF₂ₙ₊₁SO₂NHO₂SF₂ₘ₊₁Cₘ, where the sum of m and n preferably ranges from 8 to 17. These perfluoroalkanesulfonimide coating materials can be made from starting materials having the general formula CnF₂ₙ₊₁SO₂N(A)O₂SF₂ₘ₊₁Cₘ, where the sum of m and n preferably ranges from 8 to 17 and A is selected from the group consisting of Na, Li, ammonium, and alkyl ammonium. These starting materials are then exposed to sulfuric acid, which hydrolyzes the imide to its protonic form (i.e. A being H). It is the protonic form of the imide that forms the coating material. In one exemplary aspect, m equals 4 and n equals 4. In another exemplary aspect, m equals 8 and n equals 4. Preferably, m equals 8 and n equals 8. When the sum of m and n is greater than 17, the coating material becomes highly hydrophobic. When the sum of m and n is less than 8, the coating material becomes highly hydrophilic. As discussed above, neither highly hydrophobic nor highly hydrophilic coating materials are desired for use in direct methanol fuel cells. In another alternative embodiment, the coating material is selected from the group consisting of perfluorooctanesulfonic acid, perfluorododecanesulfonic acid, perfluoroheptadecanesulfonic acid, bis-perfluoro-n-butylsulfonimide, bis-perfluoro-n-octylsulfonimide, and perfluoro-n-butyl-perfluoro-n-octylsulfonimide.

The highly acidic nature of these long chain sulfonic acids and imides makes them particularly desirable for use in DMFCs. However, the coating materials according to this invention can be used in any fuel cell using fuels such as hydrogen, formic acid, ethanol, dimethoxymethane, trimethoxymethane and related organics.

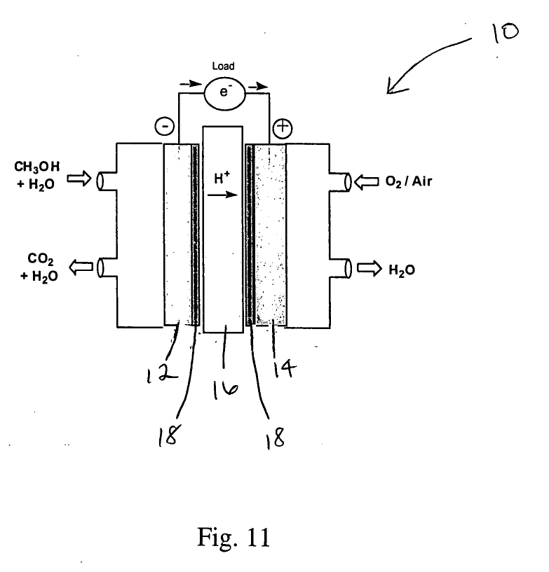

A fuel cell 10 utilizing a coating material of the present invention is shown in FIG. 11, and comprises an anode 12 coated with a coating material according to the invention, a cathode 14 also coated with a coating material according to the invention, and an electrolyte 16. The anode 12 electrochemically oxidizes the methanol. This oxidation of methanol produces electrons which travel through an external circuit to the cathode 14. The electrolyte 16 conducts protons from the anode to the cathode to maintain the internal circuit of the fuel cell 10. The protons and electrons are then consumed by the oxygen at the cathode 14 in a reduction reaction. The electrons, protons and oxygen gather at the cathode and form water. Preferably, the anode 12 and the cathode 14 each also comprise a catalyst 18 for catalyzing the oxidation of methanol. The catalyst 18 is preferably selected from the group consisting of Pt, Pt—Ru and Pt—Sn. The details of operation of DMFCs are known in the art and are disclosed in U.S. Pat. No. 6,703,150, the disclosure of which is incorporated herein by reference.

The coating materials of the present invention are particularly useful on carbon electrodes comprising Pt, Pt—Ru and Pt—Sn catalysts. The coating material is applied to the anode catalyst or the cathode catalyst either by dipping the electrodes in dilute methanol solutions containing the coating material, by painting the solutions directly onto the electrode surfaces, or by mixing the coating material with the electrolyte. When the coating material is mixed with the electrolyte, the coating material attaches itself to the electrode surface during operation of the fuel cell. Preferably, the coating material is applied to the electrodes to a loading level ranging from about 2 to about 3 mg/cm². However, perfluoroalkanesulfonimide coating materials-having a m value of 8 and a n value of 8 may be applied to the electrodes to a broader loading level range, i.e. from about 0.1 mg/cm² to about 4 mg/cm². In addition, the coating thickness preferably ranges from about 0.5 mm to about 2.0 mm. This thickness range imparts improved polarization characteristics. However, increases in coating thickness above about 2.0 mm result in a reduction in oxygen diffusion to the electrode causing a more negative open circuit potential and undesirable increases in polarization.

Testing Methods

Perfluorooctanesulfonic acid was prepared from its potassium salt by distillation over 100% sulfuric acid. Perfluorododecanesulfonic acid and perfluoroheptadecanesulfonic acid were synthesized from their corresponding perflouroalkyl iodides. Bis-perfluoro-n-butylsulfonimide, bis-perfluoro-n-octylsulfonimide and perfluoro-n-butyl-perfluoro-n-octylsulfonimide were synthesized from their corresponding perfluoroalkanesulfonyl fluorides, as is known in the art. Each of these synthesized coating materials were then subjected to various polarization and stability measurements, which were compared to measurements taken for a Nafion® coated electrode. In addition, a cyclic voltammogram was taken of a bis-perfluoro-n-octylsulfonimide coated electrode and compared to that of a Nafion® coated electrode.

Polarization Measurements

Steady-state galvanostatic polarization measurements were taken in a water-jacketed three-electrode cell containing aqueous solutions of 1 M methanol and 0.5 M H₂SO₄. Five separate working electrodes were created by coating five carbon electrodes having Pt or Pt—Sn catalysts with a different one of the following coating materials: perfluorooctanesulfonic acid, perfluorododecanesulfonic acid, perfluoroheptadecanesulfonic acid, bis-perfluoro-n-butylsulfonimide, bis-perflouro-n-octylsulfonimide, or perfluoro-n-butyl-perfluoro-n-octylsulfonimide. The counter electrode comprised platinum foil separated from the working electrode by a fine glass frit. A Hg/H₂SO₄ (1.8 M H₂SO₄) reference electrode was used to sense the potential of the working electrode through a Luggin capillary and a restricted flowing junction.

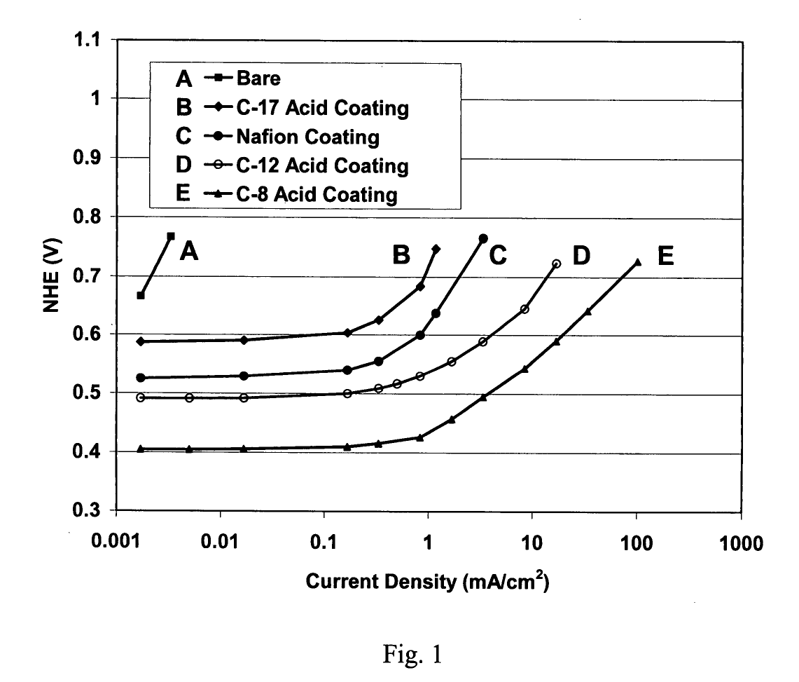

FIG. 1 depicts the polarization curves of carbon electrodes with Pt—Sn catalysts coated with different embodiments of perfluoroalkanesulfonic acid coating materials according to this invention. As shown, the potential of the perfluorododecanesulfonic acid coated electrode is lower than that of Nafion® at any current density, but higher than that of the perfluorooctanesulfonic acid coated electrode at any current density. However, the perfluoroheptadecanesulfonic acid coated electrode shows poorer performance than the Nafion® coated electrode. FIG. 1 demonstrates that although perfluoroalkanesulfonic acids with increasingly long carbon chains are less soluble in water, desirable properties such as wettability, permeability and proton conductivity are likely determined by surface groups and crystal packing in the coating material. Therefore, as shown in FIG. 1, the perfluorododecanesulfonic acid, having a 12 carbon chain, exhibits an advantageous combination of high permeability, good wettability and high ionic conductivity.

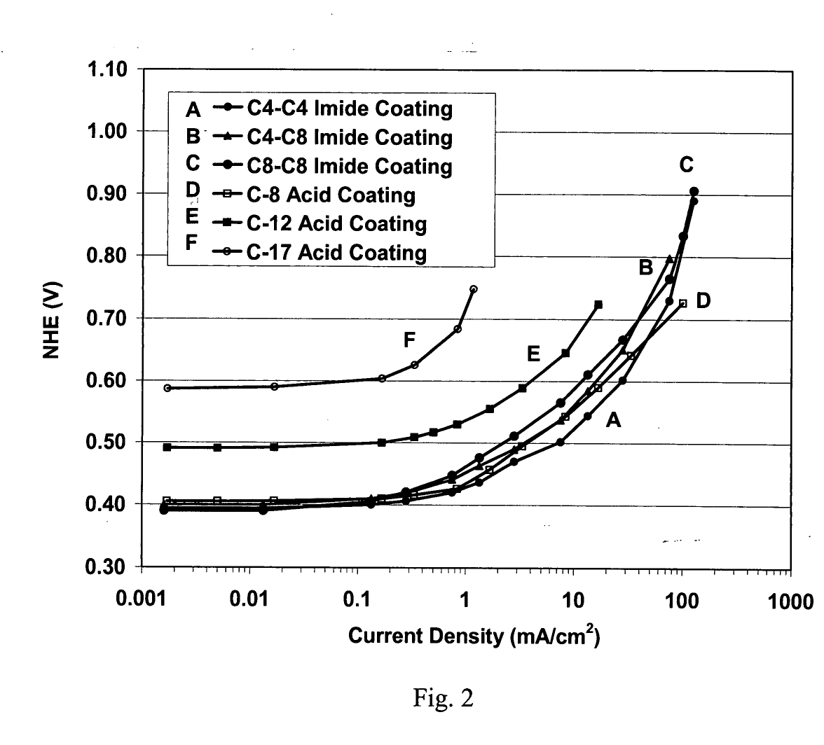

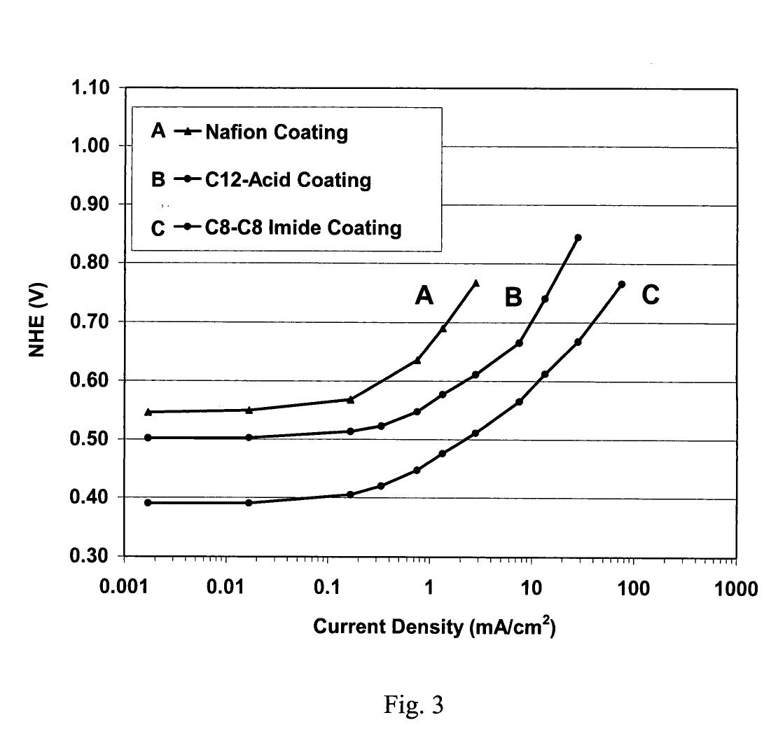

FIGS. 2 and 3 depict the polarization behavior of methanol oxidation on carbon electrodes with Pt—Sn catalysts coated with different embodiments of perfluoroalkanesulfonimide coating materials and perfluoroalkanesulfonic acid coating materials in comparison with a Nafion® coated electrode. As shown in FIG. 2, no significant differences exist in the polarization behavior of electrodes coated with the alternative perfluoroalkanesulfonimide coating materials. Also, in contrast to perfluorooctanesulfonic acid, bis-perfluoro-n-octylsulfonimide is only sparingly soluble in water, and is thus more suitable for aqueous liquid-feed fuel cell systems, such as DMFCs. Bis-perfluoro-n-octylsulfonimide is highly soluble in methanol, rendering the coating highly permeable to methanol. In addition, the perfluoroalkanesulfonimides prevent anion adsorption on noble metal catalysts due to their favorable low nucleophilicity anion properties for the electro-reduction of oxygen. Also, the perfluoroalkanesulfonimides are electrochemically stable under acidic conditions.

Although the slopes of the polarization curves for electrodes coated with perfluorooctanesulfonic acid, perfluorododecanesulfonic acid and bis-perfluoro-n-octylsulfonimide are similar, the actual current densities achieved at given potentials are quite different, as shown in FIG. 2. This demonstrates that bis-perfluoro-n-octylsulfonimide has the highest electrochemically active area. However, no differences appear to exist in mass transport rate and ionic conductivity between these coating materials. The reduced level of polarization over the entire range of current densities exhibited by electrodes coated with perfluoroalkanesulfonic acids and perfluoroalkanesulfonimides renders these coated electrodes desirable for use in DMFCs.

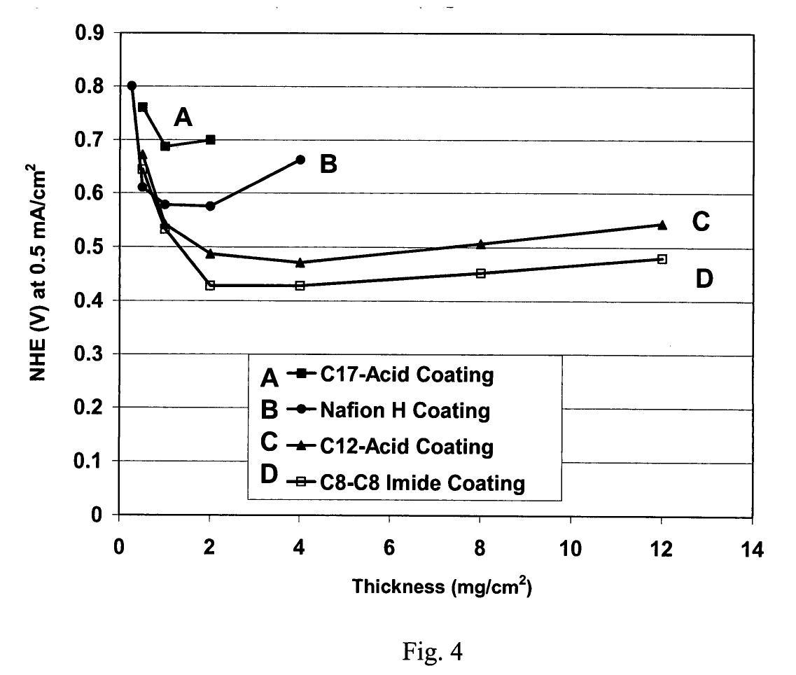

FIG. 4 depicts the polarization behavior at different loading levels of three different perfluoroalkanesulfonic acids and imides measured as a function of coating thickness. The optimum loading level for the coating materials corresponds to the minimum polarization. Accordingly, as shown in FIG. 4, the loading levels for most coating materials are preferably between about 2 mg/cm² and about 3 mg/cm². However, as shown, the loading levels for bis-perfluoro-n-octylsulfonimide cover a broader range, i.e. from about 0.1 mg/cm² to about 4 mg/cm². The broader loading level range of bis-perfluoro-n-octylsulfonimide demonstrates that this coating material has a good combination of ionic conductivity, permeability and distribution at the electrocatalyst/solution interface.

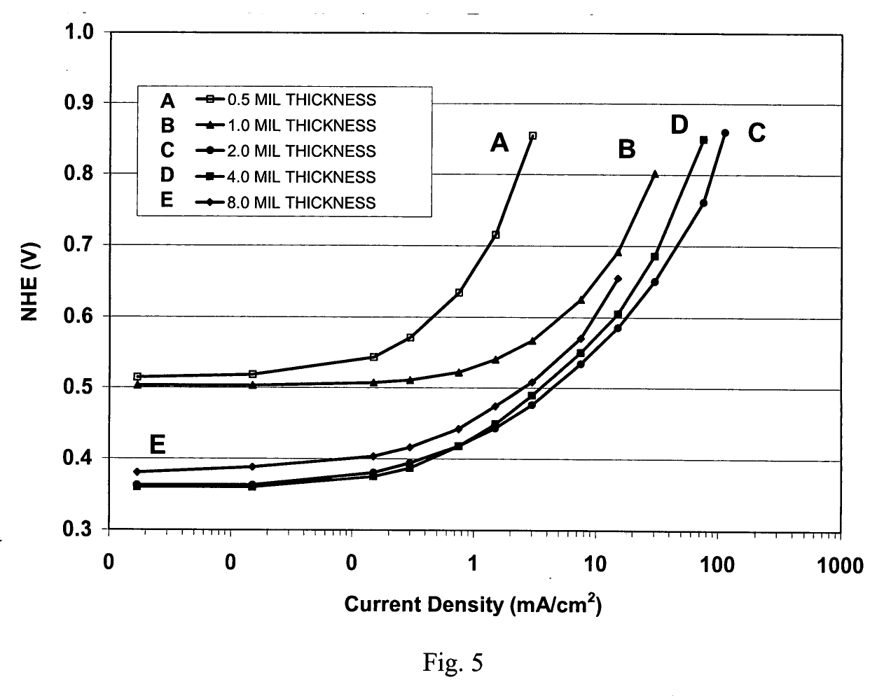

FIG. 5 depicts the polarization behavior of bis-perfluoro-n-octylsulfonimide at varying coating thicknesses. As shown, the open circuit potential presented by the imide coated electrodes depends on the coating thickness. The open circuit potential is a mixed potential resulting from several intermediate surface processes including contributions from the electro-reduction of dissolved oxygen in the solution. Thicker coatings reduce oxygen diffusion to the electrode, resulting in a more negative open circuit potential. As shown in FIG. 5, the polarization characteristics of the bis-perfluoro-n-octylsulfonimide coated electrode improve when the coating is applied within a thickness ranging from about 0.5 mm to about 2 mm. However, polarization undesirably increases when the thickness is increased to about 4 mm and about 8 mm. This increased polarization is likely caused by the increased ohmic impedance presented by thicker coatings.

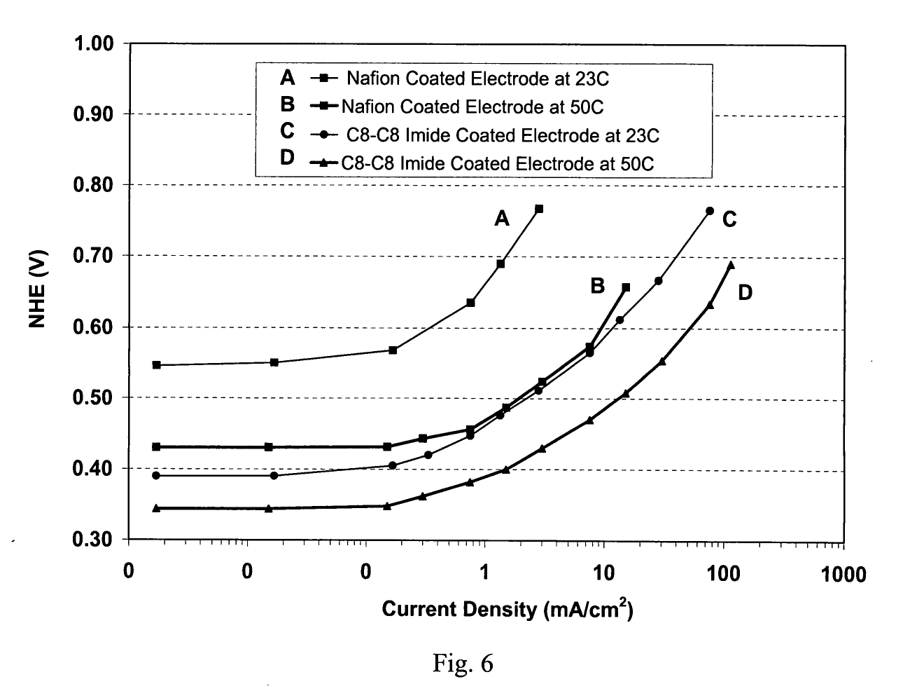

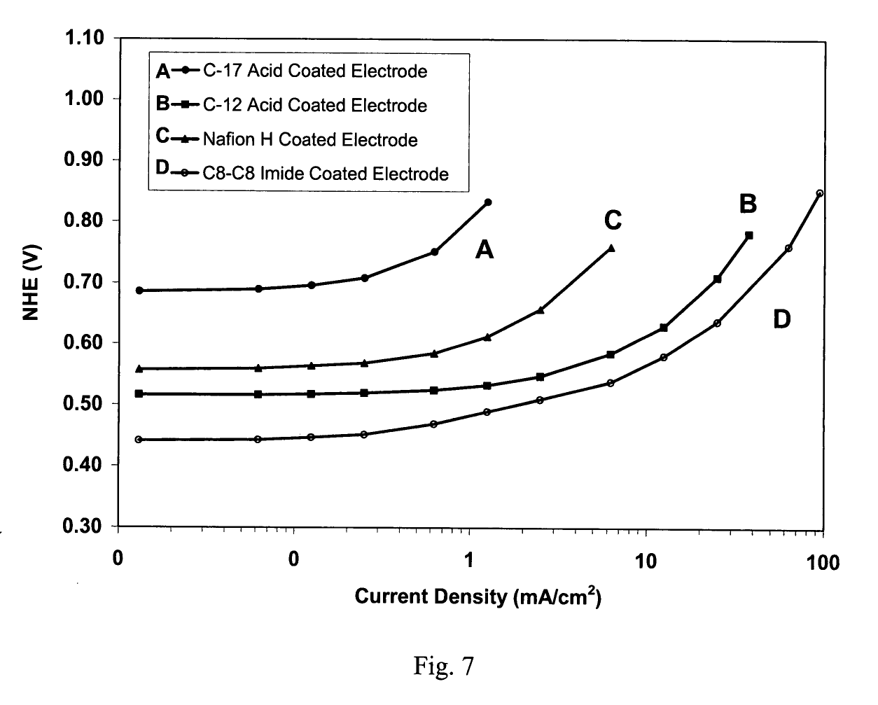

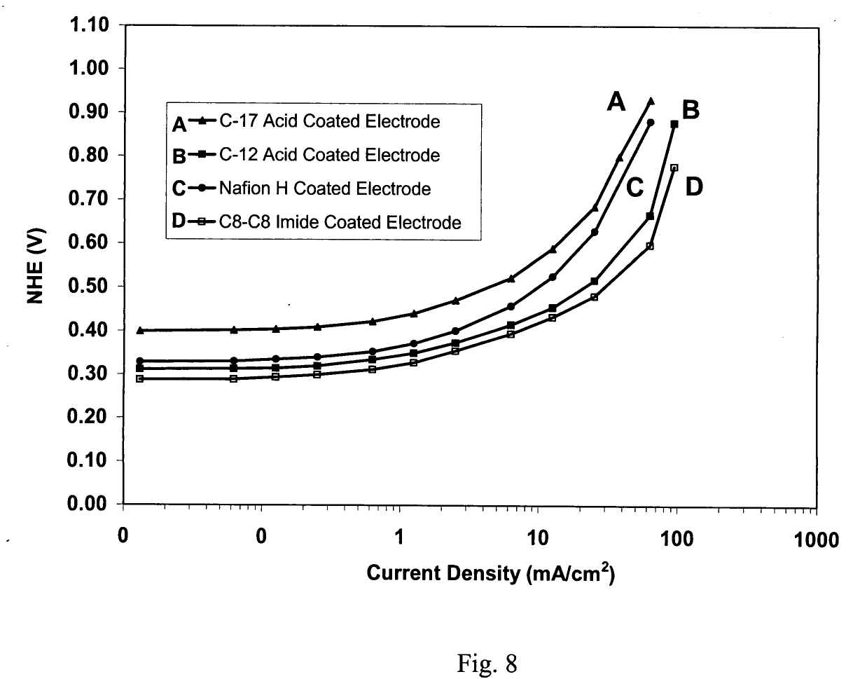

FIG. 6 depicts the polarization behavior of electrodes coated with bis-perfluoro-n-octylsulfonimide and Nafion® at 23° C. and 50° C. As shown, the polarization of the imide coated electrode decreased by about 70 mV upon an increase in temperature from 23° C. to 50° C. In contrast, the Nafion® coated electrode decreased by about 100 mV upon the same increase in temperature. However, there is no significant difference in the slopes of the polarization curves as a function of temperature. Accordingly, the effect of temperature on the kinetics of methanol oxidation is similar for both imide coated and Nafion® coated electrodes. FIGS. 7 and 8 depict similar results for electrodes coated with other perfluoroalkanesulfonic acids and perfluoroalkanesulfonimides.

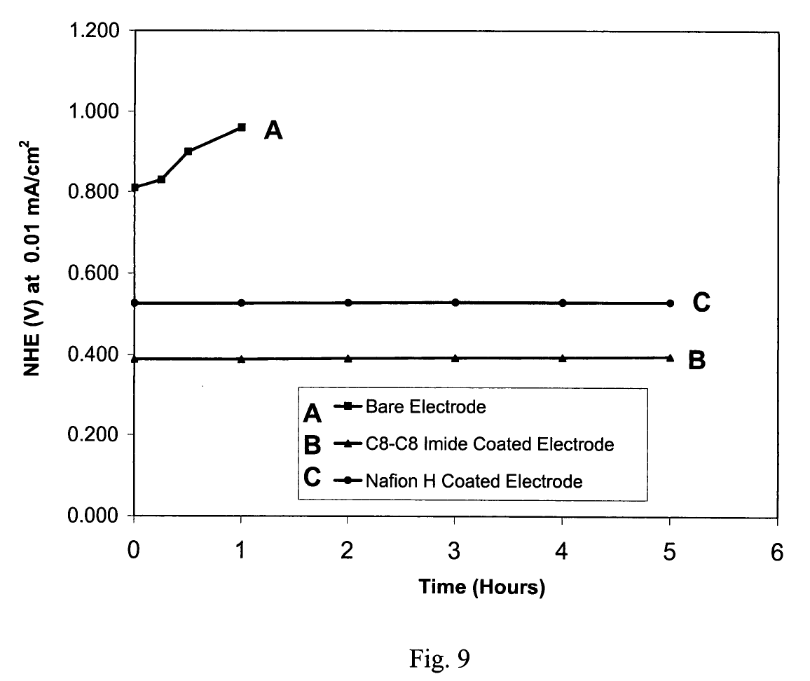

FIG. 9 depicts the stability over time of a bis-perfluoro-n-octylsulfonimide coated electrode and a Nafion® coated electrode measured against a bare electrode. As shown, over several hours of operation, the imide and Nafion® coated electrodes showed no significant change in electrode potential. In contrast, the bare electrode showed increased polarization.

Cyclic Voltammetry

Cyclic voltammograms were taken in a three-electrode cell comprising a platinum working electrode, platinum foil counter electrode and a Hg/Hg₂SO₄ (1.8 M H₂SO₄) reference electrode (+0.650 V versus NHE (normal hydrogen electrode)). The electrode was cycled through the potential window 1.200 V to −0.010 V versus NHE in a supporting electrolyte of 0.5 M H₂SO₄ solution. The cyclic voltammetry was carried out in 0.01 M methanol solution. Voltammograms were taken of a bare Pt electrode, a Nafion® coated Pt electrode and a Pt electrode coated with bis-perflouro-n-octylsulfonimide. Cyclic voltammograms and steady state polarization date were obtained with a PAR Model 173 potentiostat/galvanostat, a PAR Model 175 universal programmer, and were recorded with a Soltec X-Y recorder.

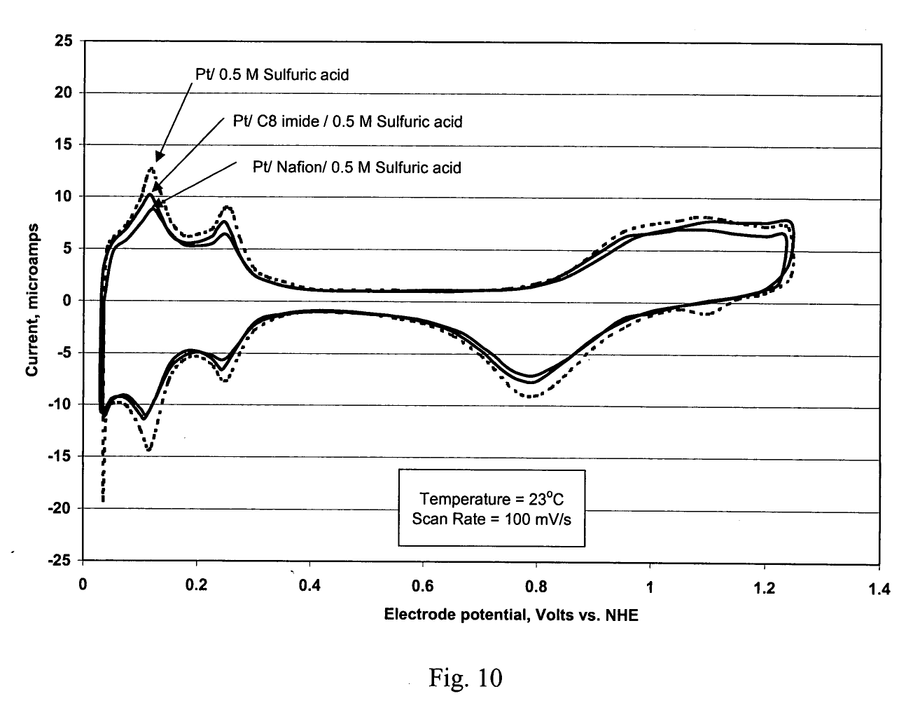

Cyclic voltammetry was used to evaluate the electrochemical stability of a bis-perfluoro-n-octylsulfonimide coated electrode under acidic conditions. FIG. 10 depicts the cyclic voltammograms of a bis-perfluoro-n-octylsulfonimide coated electrode, a Nafion® coated electrode and a bare electrode. FIG. 10 shows no decomposition of the imide coating as a result of contact with the acidic solution. In addition, the resolution of hydride regions between 0.05 V and 0.30 V versus NHE indicates good proton conductivity of the imide coated electrode surface. The Nafion® coated electrode exhibited similar results.

As shown by the polarization and stability measurements, and the cyclic voltammograms described above, the perfluoroalkanesulfonic acids and imides according to this invention are electrochemically stable under acidic conditions, such as those present in a DMFC. In addition, these acids and imides contain favorably low nucleophilicity properties, such that the anions do not attach themselves to the catalyst layer, making the catalyst available to catalyze the oxidation of methanol. Also, the coating materials of this invention provide high ionic conductivity at the electrode/electrolyte membrane interface and impart good wettability and permeability to the anode. The coating materials of the present invention also enhance cathode performance by enhancing oxygen solubility, thereby aiding the transfer of oxygen to the cathode.

The preceding description has been presented with reference to the presently preferred embodiments of the invention. Workers skilled in the art and technology to which this invention pertains will appreciate that alterations and modifications may be made to the described embodiments without meaningfully departing from the principal, spirit and scope of this invention. Accordingly, the foregoing description should not be read as pertaining only to the precise embodiments described, but rather should be read as consistent with, and as support for, the following claims, which are to have their fullest and fairest scope.

1. An electrode for use in a fuel cell comprising:
an electrode body; and
a coating material comprising one or more materials selected from the group consisting of perfluoroalkanesulfonic acids having the general formula F₃C—(CF₂)—SO₃H, wherein n ranges from 8 to 17;
wherein the coating material is applied to the electrode body.

2. The electrode of claim 1, wherein n equals 8.

3. The electrode of claim 1, wherein n equals 10.

4. The electrode of claim 1, wherein n equals 12.

5. The electrode of claim 1, wherein n equals 17.

6. The electrode of claim 1, wherein the electrode is an anode.

7. The electrode of claim 1, wherein the electrode is a cathode.

8. The electrode of claim 1, further comprising a catalyst.

9. The electrode of claim 8, wherein the catalyst comprises a material selected from the group consisting of Pt, Pt—Ru and Pt—Sn.

10. The electrode of claim 1, wherein the coating material is applied to the electrode body to a loading level ranging from about 2 mg/cm² to about 3 mg/cm².

11. The electrode of claim 1, wherein the coating material is applied to the electrode body to a thickness ranging from about 0.5 mm to about 2.0 mm.

12. An electrode for use in a fuel cell comprising:
an electrode body; and
a coating material comprising one or more materials selected from the group consisting of perfluoroalkanesulfonimides having the general formula CₙF₂ₙ₊₁SO₂NHO₂SF₂ₘ₊₁Cₘ, wherein the sum of m and n ranges from 8 to 17;
wherein the coating material is applied to the electrode body.

13. The electrode of claim 12, wherein n equals 4 and m equals 4.

14. The electrode of claim 12, wherein n equals 8 and m equals 8.

15. The electrode of claim 14, wherein the coating material is applied to the electrode to a loading level ranging from about 0.1 mg/c² to about 4.0 mg/cm².

16. The electrode of claim 12, wherein n equals 4 and m equals 8.

17. The electrode of claim 12, further comprising a catalyst.

18. The electrode of claim 17, wherein the catalyst comprises a material selected from the group consisting of Pt, Pt—Ru and Pt—Sn.

19. The electrode of claim 12, wherein the electrode is an anode.

20. The electrode of claim 12, wherein the electrode is a cathode.

21. The electrode of claim 12, wherein the coating material is applied to the electrode body to a loading level ranging from about 2 mg/cm² to about 3 mg/cm².

22. The electrode of claim 12, wherein the coating material is applied to the electrode to a thickness ranging from about 0.5 mm to about 2.0 mm.

23. An electrode for use in fuel cells comprising:
an electrode body; and
a coating material selected from the group consisting of:
one or more perfluoroalkanesulfonic acids having the general formula F₃C—(CF₂)ₙ—SO₃H, wherein n ranges from 8 to 17, and
one ore more perfluoroalkanesulfonimides having the general formula CₙF₂ₙ₊₁SO₂NHO₂SF₂ₘ₊₁Cₘ, wherein the sum of m and n ranges from 8 to 17;
wherein the coating material is applied to the electrode body.

24. The electrode of claim 23, further comprising a catalyst.

25. The electrode of claim 24, wherein the catalyst comprises a material selected from the group consisting of Pt, Pt—Ru and Pt—Sn.

26. The electrode of claim 23, wherein the coating material is applied to the electrode body to a loading level ranging from about 2 mg/cm² to about 3 mg/cm².

27. The electrode of claim 23, wherein the coating material comprises a perfluoroalkanesulfonimide, wherein n equals 8 and m equals 8, the coating material being applied to the electrode body to a loading level ranging from about 0.1 mg/cm² to about 4.0 mg/cm².

28. The electrode of claim 3, wherein the coating material is applied to the electrode body to a thickness ranging from about 0.5 mm to about 2.0 mm.

29. The electrode of claim 23, wherein the coating material is selected from the group consisting of perfluorooctanesulfonic acid, perfluorododecanesulfonic acid, perfluoroheptadecanesulfonic acid, bis-perfluoro-n-butylsulfonimide, bis-perfluoro-n-octylsulfonimide and perfluoro-n-butyl-perfluoro-n-octylsulfonimide.

30. A fuel cell comprising:
a cathode;
an electrolyte; and
an anode coated with one or more materials selected from the group consisting of perfluoroalkanesulfonic acids having the general formula F₃C—(CF₂)ₙ—SO₃H, wherein n ranges from 8 to 17.

31. The fuel cell of claim 30, wherein the fuel cell is a direct methanol fuel cell.

32. The fuel cell of claim 30, wherein the cathode is coated with one or more materials selected from the group consisting of perfluoroalkanesulfonic acids having the general formula F₃C—(CF₂)ₙ—SO₃H, wherein n ranges from 8 to 17.

33. A fuel cell comprising:
a cathode;
an electrolyte; and
an anode coated with one or more materials selected from the group consisting of perfluoroalkanesulfonimides having the general formula CₙF₂ₙ₊₁SO₂NHO₂SF₂ₘ₊₁Cₘ, wherein the sum of m and n ranges from 8 to 17.

34. The fuel cell of claim 33, wherein the fuel cell is a direct methanol fuel cell.

35. The fuel cell of claim 33, wherein the cathode is coated with one or more materials selected from the group consisting of perfluoroalkanesulfonimides having the general formula CₙF₂ₙ₊₁SO₂NHO₂SF₂ₘ₊₁Cₘ, wherein the sum of m and n ranges from 8 to 17.

36. A fuel cell comprising:
a cathode;
an electrolyte membrane; and
an anode coated with a material selected from the group consisting of:
one or more perfluoroalkanesulfonic acids having the general formula F₃C—(CF₂)ₙ—SO₃H, wherein n ranges from 8 to 17, and
one or more perfluoroalkanesulfonimides having the general formula CₙF₂ₙ₊₁SO₂NHO₂SF₂ₘ₊₁Cₘ, wherein the sum of m and n ranges from 8 to 17.

37. The fuel cell of claim 36, wherein the fuel cell is a direct methanol fuel cell.

38. The fuel cell of claim 36, wherein the cathode is coated with a material selected from the group consisting of:
one or more perfluoroalkanesulfonic acids, having the general formula F₃C—(CF₂)ₙ—SO₃H, wherein n ranges from 8 to 17, and
one or more perfluoroalkanesulfonimides having the general formula CₙF₂ₙ₊₁SO₂NHO₂SF₂ₘ₊₁Cₘ, wherein the sum of m and n ranges from 8 to 17.

39. The fuel cell of claim 36, wherein the anode is coated with a material selected from the group consisting of perfluorooctanesulfonic acid, perfluorododecanesulfonic acid, perfluoroheptadecanesulfonic acid, bis-perfluoro-n-butylsulfonimide, bis-perfluoro-n-octylsulfonimide, perfluoro-n-butyl-perfluoro-n-octylsulfonimide.
